(19) United States
(12) Patent Application Publication
(10) Pub. No.: US 2026/0194973 A1
(43) Pub. Date: Jul. 9, 2026

(54) ARTIFICIAL INTELLIGENCE GAZE INTERFACE SENSOR (AI GIS): PERSONALIZED BIOMETRIC DUAL-CAMERA FOVEAL GAZE TRACKING SYSTEM WITH DEVICE-ADAPTIVE ARCHITECTURE FOR PRECISE HUMAN GAZE LOCALIZATION ON DIGITAL AND PROJECTED VIEW PLANES

(71) Applicant: Cedric Daniel Thomas, Greensboro, NC (US)

(72) Inventor: Cedric Daniel Thomas, Greensboro, NC (US)

(21) Appl. No.: 19/543,871

(22) Filed: Feb. 19, 2026

(51) Int. Cl. G06F 3/01; G06F 40/30; G06T 3/4053; G06T 7/277; G06V 10/147; G06V 10/764; G06V 10/774; G06V 40/16; G06V 40/18; G06V 40/19; G06V 40/50; H04N 23/11; H04N 23/16; H04N 23/56; H04N 23/69; H04N 23/695; H04N 25/46; H04N 25/702

(52) U.S. Cl. CPC G06F 3/013; G06T 3/4053; G06T 7/277; G06V 10/147; G06V 10/764; G06V 10/774; G06V 40/171; G06V 40/172; G06V 40/19; G06V 40/197; G06V 40/50; H04N 23/11; H04N 23/16; H04N 23/56; H04N 23/69; H04N 23/695; H04N 25/46; H04N 25/702; G06F 40/30; G06T 2207/10048; G06T 2207/30201

(57) ABSTRACT

An Artificial Intelligence Gaze Interface Sensor (AI GIS) system and method for precisely tracking human gaze on a digital or projected view plane without head-mounted hardware. A context camera detects a user's face and matches it against stored biometric profiles using AI facial recognition, automatically loading personalized eye geometry, inter-pupillary distance and gaze calibration data. A conditional activation controller initializes a second Peregrine Foveal Camera (PFC), modeled after the dual-fovea retina of the Falco peregrinus, only upon confirmed eye detection. An AI algorithm triggers visual effects, hidden content, animations, gaze-based engagements and semantically mapped audio on the digital or projected plane based on gaze coordinate outputs, from a dedicated computational pipeline, correlated to the digital or projected plane. This invention serves as the sensing layer for U.S. application Ser. No. 18/395,290.

### RELATED APPLICATIONS

Continuation-in-Part of U.S. application Ser. No. 18/395,290 (Pub. No. US20250209254A1), filed Dec. 22, 2023, entitled “Artificial Intelligence Projected View Interface,” incorporated herein by reference.

### CROSS-REFERENCE TO RELATED APPLICATIONS

This application is a continuation-in-part of U.S. patent application Ser. No. 18/395,290, filed Dec. 22, 2023, entitled “Artificial Intelligence Projected View Interface” (Publication No. US20250209254A1), incorporated herein by reference in its entirety. The present invention provides the dedicated sensing layer, the Artificial Intelligence Gaze Interface Sensor (AGIS), that supplies real-time, personalized, precise gaze coordinates to the AI algorithm of the parent application across all classes of consumer digital devices.

### FIELD OF THE INVENTION

The present invention relates to artificial intelligence systems, biometric user recognition, computer vision and human-computer interaction. More particularly, the invention relates to a personalized, AI-driven, non-head-mounted gaze tracking sensor system operable across smartphones, tablets, laptops, desktop computers, smart televisions, large digital displays and augmented and virtual reality devices; comprising a biometric user classification and profile management system storing or comparing user facial geometry, inter-pupillary distance, eye socket positioning and gaze calibration mappings; a context camera with AI facial recognition that automatically identifies registered or classes of users and loads a gaze model to match their facial geometry; a conditionally activated high-acuity second camera modeled after the Falco peregrinus retinal biology; and a device-adaptive implementation architecture scaling all possible digital and projected view implementations.

### BACKGROUND OF THE INVENTION

The parent application (U.S. application Ser. No. 18/395,290) describes an Artificial Intelligence Projected View Interface (AIPVI), an AI system that tracks where a user's eyes are focused on a digital plane and triggers visual effects, animations, hidden content, audio responses, and interactive elements in and around the gaze location. The AIPVI requires a reliable, precise, non-intrusive, and universally deployable hardware-software gaze sensing system across all digital device classes. The present invention is that system.

Existing non-head-mounted gaze tracking systems suffer from three fundamental limitations the present invention resolves. First, accuracy degrades when a wide-field camera captures too few pixels per pupil, while a zoomed camera loses the spatial context needed for eye localization. No prior art resolves this trade-off through biological foveal vision architecture applied to the second camera. Second, existing systems treat every session as if the user is unknown, repeating calibration from scratch. No prior system stores a personalized biometric model per user or class of user, including inter-pupillary distance, eye socket geometry and gaze calibration data, for instant high-accuracy tracking from the first frame without re-calibration. Third, no prior system provides a unified gaze tracking architecture operable across all consumer device classes with the same AI core and personalized user model throughout.

Human eye geometry varies significantly between individuals. Inter-pupillary distance ranges from approximately 51 to 77 millimeters in adults. Eye socket depth, orbital angle and angle kappa (the offset between optical and visual axes) vary enough that a model calibrated for one person produces 3 to 8 degree errors when applied to another. At 60 cm on a 1080p display, one degree corresponds to approximately 25 pixels, enough for the AI GIS system to mis-identify which word a reader is viewing. Per-user or per user class profiles eliminate this systematic error, enabling sub-word gaze precision across sessions.

The peregrine falcon (Falco peregrinus) has the most precise biological solution to the wide-field versus high-acuity trade-off. Its dual-fovea retina provides both extreme central resolution and broad peripheral awareness simultaneously, the exact combination required for high-precision non-head-mounted gaze tracking. The present invention applies this architecture to the second camera's optical design and to the AI computational model that simulates it in software on applicable devices.

Prior dual-camera eye tracking systems (U.S. Pat. No. 9,953,214B2, U.S. Pat. No. 9,311,527B1, U.S. Pat. No. 8,885,882B1, Research Foundation of the State University of New York) use a wide camera and a pan-tilt-zoom camera to locate and image the eye region. None store personalized user or user class biometric profiles; none perform facial recognition to recall pre-computed eye geometry; none apply a biological foveal optical model; none implement device-adaptive architectures spanning multiple devices; and none integrate with an AI-driven interactive digital plane content system. The present invention is novel and non-obvious with respect to all known prior art.

### SUMMARY OF THE INVENTION

The present invention provides an Artificial Intelligence Gaze Interface Sensor (AI GIS) a user centered, device-adaptive, AI-driven dual-camera gaze tracking system operable across all classes of consumer digital devices.

In a first aspect, the invention provides a system comprising: a context camera with AI facial recognition; a biometric user profile database; a user enrollment module for applicable devices; a profile-informed conditional activation controller; a Peregrine Foveal Camera or software equivalent; a device-adaptive pointing mechanism; a gaze fusion processor (dedicated computational pipeline); and an AI content-triggering output interface.

In a second aspect, the invention provides a biometric user enrollment and profile management system that captures, stores, and recalls per-user facial geometry, inter-pupillary distance, eye socket positioning, angle kappa, gaze calibration mappings, and preferred content interaction settings, with automatic multi-user recognition and seamless profile switching on shared devices. In the absence of enrolled biometric data the invention uses AI informed searches to navigate stored profiles of human faces with similar facial geometry.

In a third aspect, the invention provides a device-adaptive implementation architecture in which the same AI gaze tracking core operates across smartphones, tablets, laptops, desktop computers, smart televisions, large displays, and AR/VR devices, with physical pointing mechanisms replaced by electronic zoom and AI foveal processing on mobile devices.

In a fourth aspect, the invention provides the Peregrine Foveal Camera (PFC) as a standalone device whose compound optical architecture is modeled after the dual-fovea retina of the Falco peregrinus.

In a fifth aspect, the invention provides a method of personalized gaze-tracked AI content interaction spanning user enrollment, user classes, profile recall, foveal imaging, gaze computation, and AI-triggered visual and audio response.

In a sixth aspect, the invention provides a gaze-synchronized audio response system mapping semantic content at the gaze location to contextually relevant audio playback.

### DETAILED DESCRIPTION OF THE PREFERRED EMBODIMENTS

### I. System Overview

The Artificial Intelligence Gaze Interface Sensor (AI GIS) is a non-head-mounted, personalized AI gaze tracking system that determines where a specific, identified user's eyes are focused on a digital plane and supplies those coordinates to an AI algorithm for content interaction. The AI GIS operates across all applicable digital devices, including those not yet invented, and all classes of consumer digital devices: smartphones, tablets, laptops, desktop computers, smart televisions, large digital displays, and augmented and virtual reality devices. On devices with physical camera steering mechanisms, the AI GIS uses a servo-driven pan-tilt-zoom system. On mobile and compact devices, the AI GIS uses electronic zoom, existing multi-lens hardware, and AI computational foveal processing to achieve equivalent function without moving parts.

The AI GIS comprises three primary subsystems: (1) the Biometric User Recognition and Profile System, which identifies who, or what class of individual, is using the device and loads the matching eye geometry model; (2) the Dual-Camera Foveal Imaging System, which captures high-precision pupil imagery using the Peregrine Foveal Camera (PFC) architecture or its software equivalent; and (3) the Gaze Fusion Computational Pipeline and AI Output System, which computes precise gaze coordinates and supplies them to the AI Projected View Interface described in parent application US20250209254A1.

### II. Biometric User Enrollment and Profile Management System

### A. Overview and Purpose

The Biometric User Recognition and Profile System transforms the AI GIS from a generic gaze estimator into a personalized precision instrument that knows, from the first frame of each session, exactly where a specific person's eyes sit in their face based on their head positioning, how far apart their pupils are and how their individual gaze maps to points on the digital plane. In the absence of registered users profiles of humans with similar geometry are used to estimate initial gaze parameters. This personalization enables the AI GIS to achieve sub-word gaze accuracy across sessions without repeated explicit calibration.

### B. User Enrollment Protocol

When a new user registers with a device running the AI GIS, the system enters Enrollment Mode. The context camera captures frames across a range of natural head positions while the user follows a brief on-screen enrollment sequence. The AI enrollment module processes these frames to extract and store the following biometric parameters in the User Profile Database:

(i) Facial geometry map: a 3D mesh of facial landmark positions, outer and inner eye corners, brow ridge, nose bridge, cheekbones, used to locate the eye region in any subsequent frame regardless of head orientation.

(ii) Inter-pupillary distance (IPD): the physical distance between the centers of the user's pupils in millimeters, the single most important per-user parameter for computing accurate 3D gaze direction.

(iii) Eye socket geometry: depth and orbital angle of each eye socket, establishing the 3D eyeball center position relative to the facial landmark mesh.

(iv) Angle kappa values: the individual offset between optical and visual axes for each eye, measured during the enrollment gaze calibration procedure.

(v) Baseline PFC pointing offsets: the pan, tilt, and zoom values, or on mobile devices, the crop region and magnification parameters, to center the PFC foveal zone on each eye given the user's IPD and facial geometry at standard working distances.

(vi) Gaze calibration data: per-user computed gaze mapping to digital plane coordinates, derived from the enrollment calibration procedure using nine or more fixation targets.

(vii) Preferred interaction settings: optional per-user preferences for visual effect type, audio response volume, dwell time threshold for audio triggering, and designated interactive content regions. In the absence of these preferences the device uses profiles based on assumed personality styles derived from conventional methods. Conventional methods for classifying personality are that may be used are:
Smartphone and wearable sensing
Big-data behavioral modeling
Gamified assessments
Automated video/voice/text analysis
Computational implementations of MBTI and Big Five

The invention is not limited to these classification methods or any method of personality classification not yet invented, in the absence of preferred interaction settings

### C. Facial Recognition and Automatic Profile Recall

In every subsequent session, the context camera processes frames through the AI Face Recognition Module, which matches detected faces against stored profiles. When a face is matched with confidence, the system loads the matched user's complete profile into active working memory. The baseline PFC pointing offsets are immediately applied to the servo mechanism or electronic zoom system, pre-positioning the high-acuity imaging zone over the expected eye locations before the first pupil image is captured, delivering user centric accuracy from the first active frame of the PFC.

When no stored profile matches the detected face, the system operates in Guest Mode using classification based on classes of human facial geometry and eye geometry parameters, while offering the user the option to enroll.

### D. Automatic Multi-User Recognition and Profile Switching

Multiple users may be registered on shared devices such as family smartphones, household tablets, school laptops, office computers, public kiosks, smart televisions or any applicable digital device not yet invented. The AI GIS Multi-User Manager periodically or continuously evaluates face recognition confidence scores for all registered profiles. When the active user change is detected for the current profile and an acceptable confidence score is established for a different profile, the system seamlessly transitions to the new user's profile within a single processing cycle. No user action, button press, or menu selection is required. A user action, button press, or menu selection can be added in a desired application.

When multiple faces are simultaneously visible, the Multi-User Manager designates the primary user as the individual whose face most directly faces the display, determined by head pose angle relative to the display normal.

### III. Context Camera Subsystem

The context camera operates as intended by most devices that utilize a forward facing camera. The context camera performs: (a) continuous scene monitoring; (b) face detection and user recognition for profile loading; (c) eye region localization for pointing coordinates; (d) 3D head pose tracking; and (e) PFC activation and deactivation signaling. (f) assisting PFC camera in identifying depth and gaze location relative to digital or projected view plane.

### IV. The Peregrine Foveal Camera—Design and Biological Basis

### A. Biological Basis

The peregrine falcon possesses approximately 140 cycles per degree of visual acuity. Its dual-fovea retina, a deep central fovea (fovea centralis) providing extreme magnified resolution on a distant target, and a shallow temporal fovea (fovea temporalis) providing high-acuity peripheral spatial awareness, solves the exact engineering problem the AI GIS must solve: extreme detail on a small target with simultaneous broad spatial awareness. The present invention replicates this dual-fovea structure in engineered optical and sensor form.

### B. Dual-Fovea Optical System

The PFC optical system comprises a deep central fovea lens zone providing at least 8× magnification (preferably 10× to 20× or more) relative to the surrounding peripheral zone, modeled after the fovea centralis containing approximately 1,000,000 cones per square millimeter; and a peripheral contextual lens providing a 20 to 40 degree field of view, modeled after the fovea temporalis. An aspherical lens or lenses minimize spherical aberration at high magnification.

### C. Non-Uniform Sensor Array and Optional NIR Illumination

The PFC sensor array has non-uniform pixel density: the central foveal is modeled after the falcon's retinal cone density gradient. The PFC has the ability to include 940 nm NIR illumination: off-axis LEDs for dark-pupil contrast and on-axis LEDs for corneal Purkinje reflections. A dichroic beamsplitter would separate NIR from visible wavelengths for simultaneous NIR pupil and visible iris imaging in

### D. Conditional Activation Protocol

The PFC default state is fully dormant, sensor off and if applicable; illumination off, servo in standby. Upon confirmed face recognition and eye detection pupils are located and tracked using machine vision algorithms. In the optional setup NIR illumination activates first, then the sensor, then pointing is pre-positioned to the loaded user profile's baseline offsets. The PFC returns to dormant after a configurable timeout of no detected eye region.

### V. Device-Adaptive Implementation Architecture

The central innovation of the present invention is a unified AI gaze tracking core operating identically across all applicable devices, including those not yet invented and all consumer device classes while only the physical implementation layer adapts to each device's hardware capabilities. The biometric profile system, facial recognition, activation logic, gaze fusion algorithm and AI output interface are utilized in all implementations.

### A. Desktop, Monitor Configurations and Laptop Computers

Context camera function: built-in or connected webcam. PFC function: either (i) a compact PFC module integrated into the laptop bezel as an additional camera; (ii) the laptop's existing telephoto or high-resolution sensor; or (iii) a software-defined PFC using the webcam sensor with AI foveal processing. Physical PTZ is replaced by electronic pan (digital crop repositioning), electronic zoom (digital magnification or lens selection), and AI foveal attention processing. The loaded user profile's baseline IPD-derived crop coordinates are applied from the first frame.

Applicable Devices: Full physical PFC with servo-driven pan-tilt-zoom mechanism, complete NIR illumination and dedicated context camera mounted above or beside the display.

### C. Smartphones

Contextual AI GIS functions performed using existing front-facing camera hardware and to increase accuracy PFC camera would be added to phone architecture. The primary wide-angle front camera performs context camera function. An additional front sensor relative to the submission of this application performs PFC function. AI super-resolution of the cropped eye region; and predictive crop repositioning using the loaded user profile's baseline offsets updated by the Kalman filter. NIR illumination is available on devices with Face ID or similar IR front-camera hardware; visible-light pupil tracking is used on devices without IR.

### D. Tablets

Architecturally identical to smartphone implementations. The larger display area increases angular separation between gaze points, improving gaze point discrimination accuracy beyond what is achievable on smaller phone displays.

### E. Smart Televisions and Large Digital Displays

Implemented as a camera bar mountable above or below the display for compatible devices. For displays up to 55 inches at typical 150 to 300 cm viewing distances, a servo-driven PTZ PFC provides desired pupil resolution. For larger displays or distances beyond 300 cm, a stereoscopic dual-PFC configuration is implemented. Wide-field context cameras cover distances based on the camera resolution and applicable zoom capabilities.

### F. Augmented and Virtual Reality Devices

Implemented using the device's existing inward-facing eye tracking cameras as both context camera and PFC. Cameras positioned 30 to 50 mm from the eye achieve required pupil resolution without additional magnification or PTZ. Biometric profile, facial recognition, and gaze fusion operate identically to other device classes or if applicable an artificial intelligence algorithm trained on user/users retina profile. The digital plane is the augmented overlay surface in AR applications, or the virtual display plane in VR applications.

### F. Applicable Devices Not Yet Invented

Context and PFC camera configuration along with servo or computational AI algorithms are based on the applicable architecture of devices not yet invented.

### VI. Servo-Driven PTZ Mechanism (Desktop and Large Display Configurations)

Pan-tilt-zoom mechanism provides angular precision and tracking head movements. A Kalman filter predictive tracking module anticipates head movement and pre-positions the PFC. On session start with a recognized user, the PTZ is immediately pre-positioned to the baseline offsets from the user's profile, so the first PFC frame captures the eye region without search delay. In guest mode the system uses classes of human face geometry that best match the device user and automatically adjusts the PFC view

### VII. Gaze Fusion Processor and AI Output

The gaze fusion processor runs a staged personalized pipeline. Stage 1: load personalized eye geometry, IPD, eye socket positions, angle kappa, from the recognized user's profile. Stage 2: 3D head pose estimation from context camera landmark data referenced against the loaded facial geometry map. Stage 3: sub-pixel pupil centroid computation from PFC NIR image using ellipse fitting; corneal glint localization and pupil-to-glint vector computation corrected by personalized angle kappa. Stage 4: visual axis computation combining head pose, pupil centroid, glint vector and the personalized geometry model. Stage 5: ray-plane intersection of the visual axis with the digital display plane producing gaze coordinates (x,y) in normalized display space. PFC camera automatically adjusts to coordinates sent by contextual camera based on user head movement

These coordinates are output via API to the AI Projected View Interface of parent application US20250209254A1, which triggers visual effects, animations, hidden content, gaze-based interaction, and semantically-mapped audio based on the information at and around the user's gaze location.

### VIII. Gaze-Synchronized Audio Response System

The AI GIS gaze-synchronized audio response subsystem initiates contextually relevant audio synchronized to the user's gaze position. The AI Projected View Interface of parent application US20250209254A1 identifies content at or near the current gaze point and extracts semantic meaning. An audio mapping engine maps the extracted semantic meaning to audio responses from a predetermined or AI-generated library. For example, when a user's gaze falls on narrative text describing a character walking through cold weather, the AIPVI system extracts the semantic elements of footstep motion and cold environment and the AI GIS initiates corresponding ambient sounds, footsteps and wind synchronized to reading pace. Character dialogue triggers character voice audio. Action sequences trigger appropriate sound effects. The audio output system supports binaural and directional audio rendering and can position sounds to appear to originate from the triggering content's region of the digital plane.

### IX. Calibration

Enrollment gaze calibration presents at least nine fixation targets at known display positions and records PFC measurements during fixation of each. An AI model computes the personalized mapping function stored in the user profile. Post-calibration accuracy with a stored personalized profile is aimed to increase initial accuracy and user familiarity with generic models. An auto-calibration mode uses NLP to correlate recognized speech with text positions on the digital plane, enabling passive profile refinement during normal use.

### X. AI System Applications

The AI GIS personalized gaze coordinates are suitable for any AI system requiring precise, user-specific, real-time gaze data without head-mounted hardware across any applicable device including consumer digital devices. Primary applications include the AI Projected View Interface of the parent application; AI reading comprehension systems; AI educational engagement monitoring; AI accessibility gaze-based device control; AI driver attention monitoring; AI advertising attention measurement; AI gaming gaze interaction; and AI content personalization based on inferred viewer interest.

### XI. Alternative Embodiments

Alternative embodiments include: stereoscopic dual-PFC for improved depth estimation; single-chip foveated sensor integrating both optical zones on one CMOS die; curved-sensor PFC replicating the falcon's curved retina; cloud-hosted biometric profile database enabling a user's personalized profile to follow them across all their registered devices via encrypted synchronization without re-enrollment; AI GIS implemented entirely as a mobile application using only existing device cameras; federated profile sharing between family or enterprise devices; Digital media applications not yet invented.

### INFORMATION DISCLOSURE STATEMENT—REQUIRED CITATIONS

### U.S. Patents and Publications

1. U.S. Pat. No. 9,953,214B2—Yin et al., Research Foundation SUNY Real time eye tracking for human computer interaction. Apr. 24, 2018.
2. U.S. Pat. No. 9,311,527B1—Yin et al., Research Foundation SUNY Real time eye tracking for human computer interaction. Apr. 12, 2016.
3. U.S. Pat. No. 8,885,882B1—Yin et al., Research Foundation SUNY Real time eye tracking for human computer interaction. Nov. 11, 2014.
4. US20160210503A1—Yin et al. Publication. Jul. 21, 2016.
5. U.S. Pat. No. 5,231,674—A Friedman et al. Apparatus and method for detecting and tracking eye movement. Jul. 27, 1993.
6. US20250209254A1—Thomas, Cedric Daniel. Artificial Intelligence Projected View Interface. PARENT APPLICATION.

| | |
|---|---|
| Claims | Independent and dependent claims made for |
| Pg. 17 | patent application. |
| Abstract | Brief description of invention for searchable |
| Pg. 29 | databases. |

1. A user-centric artificial intelligence gaze interface sensor system for non-head-mounted gaze tracking on a digital plane across multiple device classes, comprising:
a context camera configured to continuously capture images of a scene;
an artificial intelligence face recognition module configured to detect a user's face in camera images, match the detected face against stored biometric profiles or user classifications based on facial geometry in a user profile database, and automatically load the matched user's personalized biometric profile;
a user profile database storing, for each registered user or user classification, a facial geometry map, an inter-pupillary distance measurement, eye socket geometry parameters, per-eye angle kappa values, a gaze calibration polynomial mapping gaze vectors to digital plane coordinates, and preferred interaction settings;
a conditional activation controller configured to maintain a second high-acuity foveal camera in a dormant low-power state, transition said second camera to an active state upon confirmed detection of a registered or classified user's eye regions, apply the loaded user's personalized baseline pointing offsets to a pointing mechanism upon activation, and allow configuration of the high-acuity foveal camera or cameras while in guest mode to increase the accuracy of pointing parameters from user classes to match unregistered users;
said second camera being a high-acuity foveal imaging camera whose optical system is architecturally modeled after the dual-fovea retinal structure of the Falco peregrinus, comprising a deep central fovea lens zone providing at least 8× magnification modeled after the fovea centralis and a peripheral contextual lens zone modeled after the fovea temporalis;
a device-adaptive pointing mechanism configured to steer the second camera's high-acuity imaging zone toward detected eye coordinates, implemented as a servo-driven pan-tilt-zoom mechanism or as electronic zoom and AI-driven foveal processing;
a gaze fusion processor configured to incorporate the loaded or classified user's personalized biometric profile to compute a precise 3D visual axis and intersect said visual axis with the digital plane to produce a gaze point coordinate; and
an output interface configured to supply said gaze point coordinate to an artificial intelligence algorithm that triggers context-aware responses at the user's gaze location on the digital plane.

2. A biometric user enrollment and profile management system for a personalized gaze tracking device, comprising:
a user enrollment module configured to guide a new user through an enrollment sequence capturing images of the user's face across a plurality of head orientations using a context camera;
a biometric extraction engine configured to process enrollment images and store in a user profile database a facial geometry map of 3D facial landmark positions, an inter-pupillary distance, eye socket depth and orbital angle parameters, per-eye angle kappa values, baseline pointing offsets for a high-acuity second camera keyed to the user's inter-pupillary distance and facial geometry, a gaze calibration polynomial mapping computed gaze vectors to digital plane coordinates, and preferred interaction settings comprising visual effect preferences, audio response volume, and dwell time threshold;
a facial recognition module configured to match faces detected during subsequent sessions against stored profiles and automatically load a matched user's profile without requiring user input;
a multi-user manager configured to continuously evaluate recognition confidence for all registered profiles simultaneously and seamlessly transition the active user profile when a different registered user is detected without requiring any user action or menu selection;
a guest mode module configured to operate with classifications of facial and eye geometry parameters when no registered profile matches the detected face while presenting an option to enroll; and
the use of a Peregrine Foveal Camera (PFC) to store images of pupil and eye characteristics or train an AI algorithm on the aforementioned to identify and classify users.

3. A method for personalized artificial intelligence gaze tracking on a digital plane, comprising:
capturing images of a scene with a context camera or using a Peregrine Foveal Camera (PFC) to capture or train an AI algorithm on images of characteristics of the user's eyes and processing said images with an AI facial recognition model to detect and identify a user;
matching the detected face or eye characteristics against stored biometric profiles and, upon a match, loading the matched user's personalized biometric profile including facial geometry, inter-pupillary distance, eye socket geometry, angle kappa values, and gaze calibration;
pre-positioning a high-acuity second camera or electronic zoom crop region to baseline pointing coordinates derived from the loaded user's inter-pupillary distance and facial geometry;
maintaining the second camera in a dormant state until the context camera confirms detection of at least one eye region with confidence exceeding a threshold and then activating the second camera;
capturing a high-magnification image of the user's pupil using the second camera whose optical system is modeled after the dual-fovea retinal structure of the Falco peregrinus;
computing a sub-pixel pupil centroid and corneal glint vector from high-magnification and contextual images;
incorporating the loaded user's personalized angle kappa and gaze calibration polynomial to compute a precise 3D visual axis and intersect said axis with the digital plane to determine a gaze point coordinate; and
supplying said gaze point coordinate to an artificial intelligence algorithm that triggers a context-aware response at the gaze location on the digital or projected plane.

4. A high-acuity foveal imaging camera for artificial intelligence gaze tracking applications modeled after the visual system of the Falco peregrinus, comprising:
a compound optical system arranged co-axially wherein the deep central fovea lens zone provides at least 8× magnification relative to the peripheral zone and is modeled after the fovea centralis of the Falco peregrinus retina and the peripheral contextual zone is modeled after the fovea temporalis;
an image sensor with a central high-density pixel zone and a surrounding lower-density pixel zone wherein pixel density decreases from center to periphery in a gradient modeled after the Falco peregrinus retinal cone density gradient;
a near-infrared illumination subsystem comprising off-axis LEDs for dark-pupil imaging and on-axis LEDs for corneal Purkinje reflection generation; and
a conditional power interface configured to receive an activation signal from an external eye detection system and transition from a dormant state to an active imaging state upon receipt thereof.

5. An artificial intelligence gaze-triggered digital interface system comprising the personalized artificial intelligence gaze interface sensor system of claim 1 and an artificial intelligence projected view interface algorithm operably connected to the gaze fusion processor of claim 1 and configured to receive personalized gaze point coordinates, map said coordinates to content regions on a digital display or projected view plane, and trigger visual effects, reveal hidden content, animate text or characters, play semantically mapped audio, or activate interactive elements at or near the gaze point location based on whether the gaze point falls within a defined trigger region.

6. A gaze-synchronized audio response system for use with a personalized artificial intelligence gaze interface sensor comprising:
a gaze coordinate receiver configured to receive real-time gaze point coordinates identifying a location on a digital plane where a user's eyes are focused;
an artificial intelligence projected view interface algorithm operably connected to the gaze fusion processor of claim 1 and configured to identify content at or near said gaze point coordinates and extract semantic meaning using natural language processing, image recognition, or a combination thereof,
an audio mapping engine configured to map said extracted semantic meaning to one or more audio responses from a predetermined or AI-generated audio library based on contextual relevance between the content and the audio response; and
an audio output system configured to play said mapped audio response synchronized to the user's gaze dwelling at or passing through the content region associated with said semantic meaning.

1.1. The system of claim 1, wherein on a device with a digital or projected plane the device-adaptive pointing mechanism operates without any moving mechanical parts by repositioning an electronic zoom crop region on an existing device image sensor to coordinates derived from the loaded user's stored inter-pupillary distance and facial geometry and applying artificial intelligence super-resolution processing to the cropped eye region to simulate the magnification of the Falco peregrinus deep central fovea lens zone.

1.2. The system of claim 1, wherein the context camera function is performed by an existing front-facing camera already present on the device and the second high-acuity foveal camera function is performed by one of an existing telephoto front-facing camera on the device, a software-defined foveal AI processing model applied to said existing camera's output, or a compact PFC module integrated into the device housing.

1.3. The system of claim 1, operable across device classes selected from smartphones, tablets, laptop computers, desktop computers, smart televisions, large digital displays, interactive kiosks, augmented reality devices, virtual reality devices, and devices not yet invented, wherein the AI gaze tracking core, biometric profile system, and personalized gaze model operate across all device classes.

1.4. The system of claim 1, wherein the user profile database is stored locally on the device and further synchronized via encrypted transmission to a cloud-hosted profile database, enabling the user's personalized gaze model or gaze model classification to be available on any registered device without re-enrollment.

1.5. The system of claim 1, further comprising a predictive tracking module applying a Kalman filter to a history of eye position measurements from the context camera to predict future eye position and pre-position the pointing mechanism ahead of observed head movement to reduce tracking latency.

1.6. The system of claim 1, wherein the second camera further comprises a near-infrared illumination subsystem comprising off-axis LEDs producing dark-pupil contrast and on-axis LEDs generating corneal Purkinje reflections and a dichroic beamsplitter enabling simultaneous near-infrared pupil and visible-spectrum iris imaging.

1.7. The system of claim 1, further comprising an auto-calibration module using natural language processing to correlate recognized speech from the user with positions of corresponding text on the digital plane and passively refining the user's stored gaze calibration during normal use without explicit calibration sessions.

1.8. The system of claim 1, wherein the artificial intelligence algorithm triggered by gaze point coordinates activates visual effects selected from glitter effects, sparkle effects, background animations, changing letter forms, bold text effects, emotion animations, hidden characters revealed by gaze, and animated transitions around text or images.

1.9. The system of claim 1, wherein gaze point coordinates are supplied to one or more AI systems selected from an AI reading comprehension assessment system, an AI driver attention monitoring system, an AI accessibility gaze-control interface, an AI advertising attention measurement system, an AI educational engagement monitoring system, and an AI gaming gaze-interaction system.

2.1. The biometric user enrollment and profile management system of claim 2, wherein the enrollment sequence presents nine or more fixation targets at known digital plane positions, captures pupil centroid and corneal glint measurements during fixation at each target, and computes the gaze calibration polynomial from the resulting dataset.

2.2. The biometric user enrollment and profile management system of claim 2, wherein the multi-user manager transitions between registered user profiles within a single processing cycle without requiring any user action, button press, or menu selection.

2.3. The biometric user enrollment and profile management system of claim 2, wherein when multiple registered users are simultaneously present in the scene the multi-user manager designates the primary user as the individual whose face most directly faces the display as determined by head pose angle relative to the display normal.

2.4. The biometric user enrollment and profile management system of claim 2, wherein the user profile database further stores per-user auto-generated or preferred interaction settings comprising one or more of preferred visual effect type, audio response volume level, dwell time threshold for audio triggering, language preference for natural language processing, and content regions manually designated by the user as interactive trigger zones.

3.1. The method of claim 3, further comprising, when no stored profile matches the detected face, operating in guest mode using facial geometry classifications, inter-pupillary distance, and eye geometry parameters to calibrate based on user classifications and presenting an option to the unrecognized user to enroll a new biometric profile.

3.2. The method of claim 3, further comprising passively refining the loaded user's stored gaze calibration data during the session by correlating high-confidence gaze measurements with known content positions on the digital plane and writing updated calibration coefficients to the user's stored profile at session end.

3.3. The method of claim 3, wherein on a device with a digital or projected view plane the step of pre-positioning a high-acuity second camera comprises repositioning an electronic zoom crop region on an existing device image sensor to a location derived from the loaded or classified user's stored inter-pupillary distance and facial geometry without actuating any physical mechanical pointing component.

3.4. The method of claim 3, further comprising returning the second foveal camera to the dormant state upon failure to detect an eye region for a configurable timeout period and, upon next detection of a registered user's face, loading the user's profile or classification and pre-positioning the pointing mechanism before reactivating the second camera.

4.1. The camera of claim 4, wherein the deep central fovea camera is configured to minimize spherical aberration at the magnification ratio provided by said zone.

4.2. The camera of claim 4, further configured to separate near-infrared and visible wavelength light, enabling simultaneous near-infrared pupil image acquisition and visible-spectrum iris image acquisition.

4.3. The camera of claim 4, wherein the non-uniform pixel density is implemented through on-chip pixel binning with peripheral pixels binned in groups while central foveal pixels are read individually, achieving the Falco peregrinus retinal density gradient without a custom sensor manufacturing process.

4.4. The camera of claim 4, wherein the near-infrared illumination subsystem is selected for invisibility to human users and for maximizing dark-pupil contrast through differential near-infrared absorption between the pupil aperture and surrounding iris tissue.

6.1. The gaze-synchronized audio response system of claim 6, wherein the semantic content is narrative text and the audio response comprises ambient environmental sounds corresponding to the setting, action, or atmosphere described by said text at the gaze location including footsteps, weather sounds, crowd noise, animal sounds, mechanical sounds, or musical themes.

6.2. The gaze-synchronized audio response system of claim 6, wherein the audio response is triggered by the interface with an Artificial Intelligence Projected View Interface when the user's gaze dwells within a content region for a minimum dwell time threshold stored in the user's personalized or classified profile, thereby preventing audio triggering from brief or accidental glances.

6.3. The gaze-synchronized audio response system of claim 6, wherein the audio mapping engine uses a large language model to interpret the emotional tone, physical setting, or action described by content at the gaze location or interfaces with an Artificial Intelligence Projected View Interface and selects audio matching said tone, setting, or action.

6.4. The gaze-synchronized audio response system of claim 6, wherein the audio response comprises character voice audio synchronized to text at the gaze location such that the user hears sound effects, diegetic sounds, background or ambient sounds, or dialogue as their gaze passes over said text.

6.5. The gaze-synchronized audio response system of claim 6, wherein the audio response is spatially positioned using binaural audio rendering such that sounds appear to originate from the region of the digital plane where the triggering content is located.

6.6. The gaze-synchronized audio response system of claim 6, wherein the audio mapping engine or AIPVI layers multiple simultaneous audio responses when the gaze location contains content with multiple semantic elements, producing a composite audio experience corresponding to the full semantic context of the viewed content.

6.7. The gaze-synchronized audio response system of claim 6, wherein the system further comprises an author-defined audio trigger interface allowing a content creator to manually assign specific audio responses to specific content regions or allowing an AI algorithm to automatically embed audio responses on the digital plane, overriding or supplementing the AI-generated semantic mapping.
